(19) United States
(12) Patent Application Publication
(10) Pub. No.: US 2009/0084849 A1
(43) Pub. Date: Apr. 2, 2009

(54) Method and apparatus for reading indicia

(75) Inventors: Duanfeng He, South Setauket, NY (US); Robert James Pang, Williston Park, NY (US)

Correspondence Address: Tarolli, Sundheim, Covell & Tummino L.L.P, 1300 East Ninth Street, Suite 1700, Cleveland, OH, 44114, US

(73) Assignee: SYMBOL TECHNOLOGIES, INC., Holtsville, NY (US)

(21) Appl. No.: 11/904,669

(22) Filed: Sep. 28, 2007

(51) Int. Cl. G06K 7/10

(52) U.S. Cl. 235/462.01

(57) ABSTRACT

A method and apparatus is provided for reading indicia comprising a programmable scanning system (10) capable of reading a first object (18) scanned by the apparatus. The first object (18) initiates a program (24) internal to the apparatus providing a verb configuration indicating the type of programming actions to be taken by the apparatus. The programmable scanning system (10) is capable of reading a second object (26) scanned by the apparatus. The second object is decoded by internal circuitry of the scanning system (10) to provide a symbology type. The program (24) is selectively formatted by the first object (18) to read or not read the verb configuration of the symbology type of the second object (20) in target objects to be read.

### FIELD OF THE INVENTION

The present disclosure relates to a method and apparatus for reading a variety of indicia, more particularly, an apparatus and method of programming a scanner to read a variety of indicia and parameters relating thereto.

### BACKGROUND

Various electro-optical systems have been developed for reading optical indicia, such as barcodes. A barcode is a coded pattern of graphical indicia comprised of a series of bars and spaces of varying widths, the bars and spaces having differing light reflecting characteristics. Some of the more popular barcode symbologies include: Uniform Product Code (UPC), typically used in retail stores sales; Code 39, primarily used in inventory tracking; and Postnet, which is used for encoding zip codes for U.S. Mail.

The electro-optical systems include both scanners and readers capable of reading both one-dimensional (1D) and two-dimensional (2D) barcodes. The 1D systems typically employ a laser scanner that reads the spacing between the barcodes. The 2D systems typically contain a two-dimensional pixel array that captures a reflected barcode image.

Barcode scanners and readers are used in numerous applications and are internally capable of scanning a number of barcode symbologies, typically several more than the end-user may ever have a desire to employ. As a result, conventional scanners and readers require certain programming, or the manual selection of the various barcodes desired for scanning, requiring the user be familiar with the type of symbologies before the selection can occur. In addition, not only is the operator required to know the type of symbologies so that the scan setting can be manually selected, but other parameters, such as text length, length ranges, and checksum information are also required to be set and known by the operators for different applications. As such, the user needs to be familiar with several different types of barcodes symbologies and various symbology parameters before the scanner can be programmed.

### SUMMARY

The present disclosure is directed to an apparatus for reading indicia comprising a programmable scanning system capable of reading a first object scanned by the apparatus. The first object initiates a program internal to the apparatus, providing a verb configuration indicating the type of programming actions to be taken by the apparatus. The programmable scanning system is capable of reading a second object scanned by the apparatus. The second object is decoded by internal circuitry of the scanning system to provide a symbology type. The program is selectively formatted by the first object to perform the verb configuration upon the symbology type of the second object in target objects to be read.

Another feature of the disclosure includes method for reading indicia comprising the steps of reading a first object with a programmable scanning apparatus providing a verb configuration indicating the type of programming actions to be taken by the apparatus and initiating a program internal to the programmable scanning apparatus as a result of reading the first object, and formatting the program to read the verb configuration as a result of reading the first object. The method further comprises reading a second object with the programmable scanning apparatus, indicating a symbology type to which the verb configuration is to be applied. The method also comprises formatting the program to perform the verb configuration upon the symbology type of the second object with target objects to be read.

Another aspect of the disclosure includes a scanner for scanning indicia comprising a programmable scanning means capable of reading a first indicia in the form of a barcode scanned by the scanner. The first indicia initiates a program internal to the scanner providing a verb configuration indicating the type of programming actions to be taken by the scanner. The programmable scanning means is capable of reading a second indicia in the form of a barcode, RFID tag, or RFID tag and barcode scanned by the scanner. The second indicia is decoded by a decoding means internal to the programmable scanning means to provide a symbology type. The program is selectively formatted by the first indicia scanned to perform the verb configuration upon the symbology type of the second indicia in target indicia to be read.

These and other objects, advantages, and features of the exemplary embodiment of the invention are described in detail in conjunction with the accompanying drawings.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a scanner initiating a program formatting process by selecting a verb code enabling from a scan sheet in accordance with one example embodiment;

FIG. 2 is a scanner selecting target indicia from a product during program formatting process in accordance with one example embodiment;

FIG. 3 is a scanner terminating a program formatting process by selecting an end-multiple-application verb code terminating a multiple symbology scanning program from a scan sheet accordance with one example embodiment;

FIG. 4 is a schematic representation of a scanner's internal circuitry in accordance with one example embodiment;

FIG. 5 is a block diagram illustrating a program formatting process in accordance with one example embodiment; and

FIG. 6 is a block diagram illustrating a program formatting process for multiple target indicia in accordance with another example embodiment.

### DETAILED DESCRIPTION

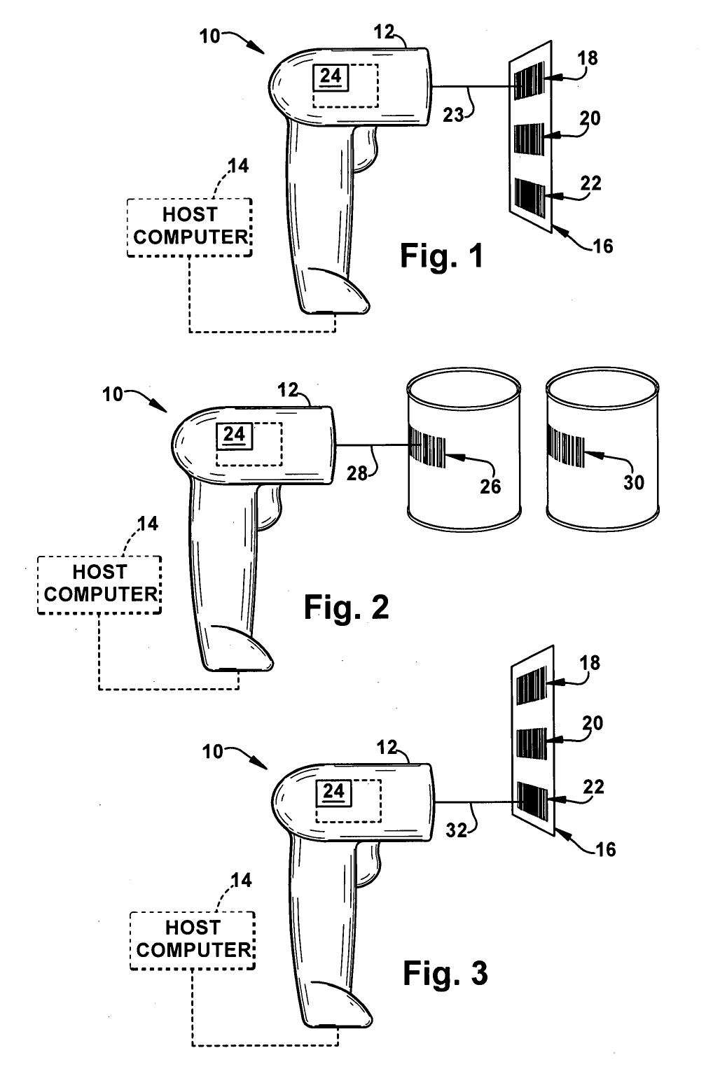

A scanning system is shown schematically at 10 in FIGS. 1-3 that includes a portable scanner 12 and in the illustrated embodiment, a separate host computer 14. Imaging and scanning as well as imagers and scanners are intended to be synonymous terms and are used interchangeably throughout, as the system 10 is capable of employing both scanning 1D and imaging 2D technology without departing from the spirit or scope of the claimed invention. Furthermore, the system 10 is illustrated having a remote host computer 14, however scanners having an internal computer and/or those scanners not required to have a host computer 14 are equally intended as suitable example embodiments of the claimed invention.

In the illustrated embodiment of FIGS. 1-3, host computer 14 is in communication with the scanner 12 either through a hard wired or wireless connection. In one example embodiment of the present invention, the scanner 12 is a hand held portable scanner that can be carried and used by a user walking or riding through a store, warehouse or plant, while scanning indicia for stocking and inventory control purposes.

One physical example of the scanner 12 includes a handle that is held by the operator and a trigger that when engaged, enables the operation of the scanner 12. Located within a scanning distance of the scanner 12 is a scan sheet 16, containing in the illustrated example embodiment of FIGS. 1 and 3 three verb codes, namely, an enable one symbology code “single-application verb code” 18, and enable multiple symbologies code “multiple-application verb code” 20, and a terminate multiple symbologies code “end-multiple-application verb code” 22. A verb code is a barcode comprising information about a specific desired act, such as enable, disable, set minimum length, enable checksum calculation, enable output of checksum, etc. The scan sheet 16 facilitates in the programming of the scanner 12 as discussed below and is intended to be provided as one of many such sheets in the scanner's user manual.

A programming process of the scanner 12 in the example embodiment of FIG. 1 is initiated by scanning the single-application verb code 18 illustrated as a barcode. In FIG. 1, the scanning of the single-application verb code is achieved by projecting a light or laser beam from the scanner 12 at the single-application verb code 18 and a single-application verb image 23 containing information representative of the single-application verb code is reflected back into the scanner, which is read by internal circuitry hardware and/or software of the scanner. The read single-application verb image 23 contains information that enables a program 24 in the internal circuitry hardware and/or software of the scanner 12 or host computer 14 for selecting the type of action to be performed on target object codes 30 desired for future scanning. The single-application verb code 18 provides instructions to the program 24 to perform a specific desired action or verb configuration, for example enabling a symbology type, disabling a symbology type, setting the minimum length, enabling the checksum calculation, enabling or disabling the output of checksum, enabling the output or disabling the output of a type of radio-frequency identification (RFID) tag, and the like. The verb configuration is applied to target object codes 30 having the same symbology types as a target object 26. To the end user operator, the target object 26 is representative of a symbology type and its data length (number of characters in the data). Accordingly, once the single-application verb image 23 is read, the operator selectively scans the target object 26, reflecting a target image 28 back into the scanner 12. The target image 28 is read and decoded by the internal circuitry hardware and/or software of the scanner 12.

Although the term program 24 is used, the programming formatting process could be used to similarly set the process logic, computer readable code, or application specific integrated circuitry internal or external to the scanner 12 without departing from the spirit and scope of the claimed invention.

Once the target image 28 is decoded, the program 24 is configured by applying the verb configuration from the single-application verb code 18 to future target object codes 30 having the same symbology type as the target object 26. For example, if the verb configuration from the single-application verb code 18 is “disable checksum output”, and the target object 26 is a UPC barcode, the program 24 on the scanner 12 is configured such that from this point on all UPC barcodes are output without the checksum characters. By way of another example, the single application verb code 18 a verb configuration the disables the output from a type of RFID tag or transponder and the target object 26 is an RFID tag. Accordingly, the program 24 on the scanner 12 is configured such that from this point on all RFID tags of the type of the target object 26 have their outputs disabled. The verb configuration from the single-application verb code 18 could be any programming task, including for example, selecting decode lengths, (one length, two lengths, length ranges, or variable lengths), enabling/disabling checksums, enabling/disabling the output of the checksums, selecting priority settings, enabling the output or disabling the output of a type of RFID tag, enabling or disabling a symbology type and the like.

In the case where it is desirable to apply one verb to a series of symbologies, a slightly modified sequence of action can be used. In this case, the multiple-application verb code 20 indicates a continuous application, such as “enable several symbologies”. After scanning the multiple-application verb code 20, a verb configuration is read, providing the verb configuration to the program 24 to be applied to future target object codes 30. The verb configuration from the multiple-application verb code 20 could be any programming task, including for example, selecting decode lengths, (one length, two lengths, length ranges, or variable lengths), enabling/disabling checksums, enabling/disabling the output of the checksums, selecting priority settings, enabling the output or disabling the output of a type of RFID tag, enabling or disabling a symbology type, and the like.

For example, after scanning the multiple-application verb code 20 and the program 24 obtains verb configuration from the multiple-application verb code 20, such as “enable checksums”, a series of target objects 26, each representing a different symbology types, such as Code 39 and Postnet are scanned to which the verb configuration is to be applied. Subsequently, all Code 39 and Postnet symbology types in future target object codes 30 that are scanned will have their checksums enabled. This sequence of programming is terminated by scanning the end-multiple-application verb code 22. The end-multiple-application verb code 22 when scanned produces an end-multiple-application verb image 32 that once decoded terminates the formatting process of the program 24 until a newly desired programming need arises. When a newly desired programming need arises, the above process is repeated by scanning the single-application verb code 18 or multiple-application verb code 20 in order to reformat the program 24 for reading the new target object.

Although the illustrated embodiment of FIGS. 1-3 depicts the target object 26, single-application verb code 18, multiple-application verb code 20, future object codes 30, and end-multiple-application verb code 22 as being barcodes, each could be any type or form of indicia such as RFID tags or barcodes containing RFID tags without departing from the spirit and scope of the claimed invention. As another example, the verb codes 18, 20, and 22 could alternatively be activated or deactivated by a button or switch on a screen of the host computer 14 or on the scanner 12. Furthermore, the target object 26 could be any of the future object codes 30 required to be scanned by the operator.

The program formatting process of the embodiments illustrated in FIGS. 1-3 advantageously allows an operator of the scanner 12 to program the scanner for reading (i.e., recognize and decode the internal data) symbology information that was unknown to the operator. A further advantage is that time is saved by comparison to programming conventional scanners, eliminating the manual steps of looking in a handbook. Another advantage of the programming formatting process results in the reduction of possible mistakes.

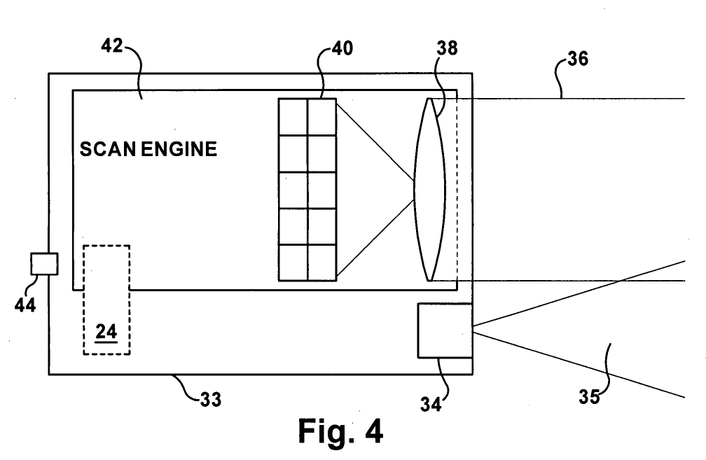

FIG. 4 illustrates the internal circuitry 33 of the scanner 12 that includes an emitter 34 such as a laser (for a scanner scanning a 1D target object 26) or light emitting diode (LED) (for an imager for imaging a 2D target object 26), projecting a beam 35 toward the target object 26 located on a package, product, or label (not shown) reflecting the verb configuration(s) desired for future scans. An image 36 is reflected from the target object 26 and altered by focusing optics 38, such as a lens. The altered image is then projected onto a photo element 40, such as a photodiode (for a scanner scanning a 1D target object 26) or pixel array (for an imager for imaging a 2D target object 26). The image obtained by the photo element 40 is then analyzed and decoded by a scan engine 42 that includes, for example in addition to the photo element 40 and focusing optics 38, an amplifier, analog-to-digital converter, and decoder for analyzing and decoding the image from a signal provided from the photo element 40. The decoded image information generated by the scan engine 42 can be transmitted from an input/output (I/O) port 44. The I/O port 44 is also capable or reading information or can be used to program the scan engine 42 from a remote source such as the host computer 14.

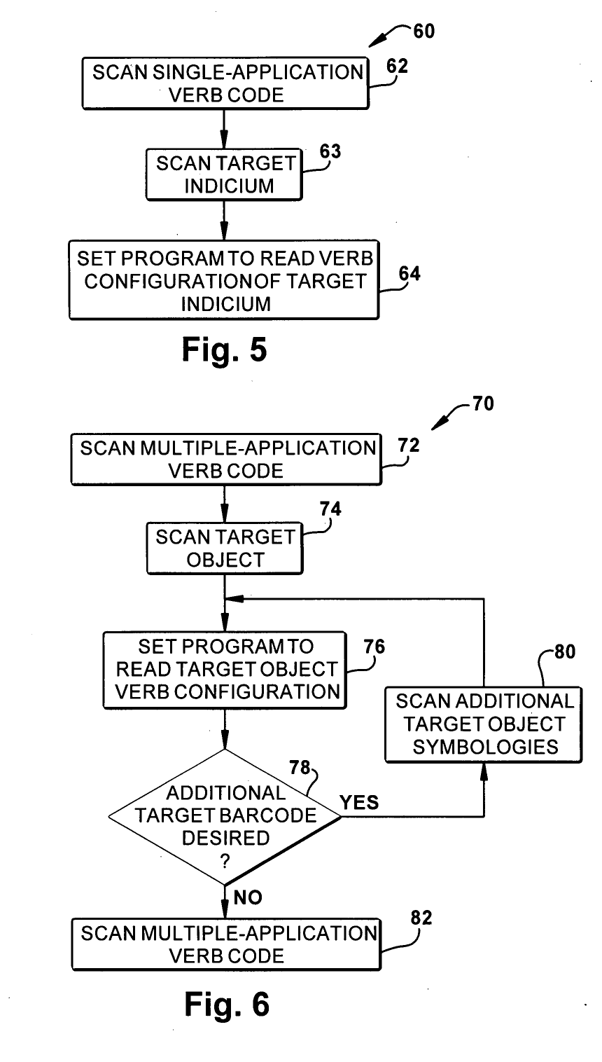

An example embodiment of a program formatting process 60 is illustrated in FIG. 5. At 62, a single-application verb code is scanned or imaged enabling a program 24 within the scanner 12 or remote computer, such as a host computer 14 to be formatted for performing a verb configurations desired by the operator. At 63, a target indicium reflecting the desired symbology type is scanned, formatting or changing the program 24 to perform the desired verb configuration on the symbology type of the target indicium. At 64, the program 24 is formatted to read the single-application verb code scanned at 62 for the symbology type matching a target indicium. The process 60 does not require a scan end verb step, as the formatting process of the program 24 automatically terminates once the target indicium is scanned or imaged. The process 60 is repeated if a new verb configuration format or symbology type is desired. Furthermore, the target indicium used at 63 to format the program 24 could be obtained from one of the target object codes 30 to be read by the scanner 12.

A further example embodiment of a program formatting process 70 is illustrated in FIG. 6, which provides for a verb configuration to be applied to target object codes having multiple symbology types. At 72, a multiple-application verb code 20 is scanned or imaged, enabling a program 24 within the scanner 12 or remote computer, such as a host computer 14 to be formatted for performing the verb configuration of the multiple-application verb code 20 desired by the operator. At 74, a target object 26 reflecting a desired symbology type is scanned or imaged. At 76, the program 24 is formatted to apply the multiple-application verb code 20 verb configuration at 72 to the desired target object symbology types identified at 74. At 78, a determination is made on whether additional target object codes having differing symbology types are desired for scanning with the verb configuration programmed at 72. If the determination at 78 is in the affirmative, the additional target object codes symbologies are scanned at 80. The process at 78 repeats until all additional desired target object code symbologies are scanned, at which time the determination at 78 is in the negative and an end-multiple-application verb code 22 is scanned or imaged, terminating the programming formatting process 70.

While the present invention has been described with a degree of particularity, it is the intent that the invention includes all modifications and alterations from the disclosed design falling with the spirit or scope of the appended claims.

We claim:

1. An apparatus for reading indicia comprising:
a programmable scanning system capable of reading a first object scanned by the apparatus, said first object initiating a program internal to the apparatus providing a verb configuration indicating the type of programming actions to be taken by the apparatus;
the programmable scanning system being capable of reading a second object scanned by the apparatus, said second object being decoded by internal circuitry of said scanning system to provide a symbology type, wherein said program is selectively formatted by said first object to perform the verb configuration upon the symbology type of the second object in target objects to be read.

2. The apparatus of claim 1 wherein said program is selectively formatted to perform the verb configuration upon target objects to be read having a plurality of symbology types.

3. The apparatus of claim 1 wherein said programmable scanning system is capable of scanning a third object scanned by the apparatus that terminates the program's ability to be selectively formatted.

4. The apparatus of claim 2 wherein said programmable scanning system is capable of scanning a third object scanned by the apparatus that terminates the program's ability to be selectively formatted.

5. The apparatus of claim 1 wherein said apparatus is a hand-held scanner.

6. The apparatus of claim 1 wherein said second object is a target object to be read.

7. The apparatus of claim 1 wherein said verb configuration includes enabling or disabling a checksum in target objects to be read.

8. The apparatus of claim 1 wherein said verb configuration includes enabling or disabling the minimum length of the target objects to be read.

9. The apparatus of claim 4 wherein said apparatus is a stationary scanner.

10. The apparatus of claim 1 wherein said apparatus is a combined barcode and RFID scanner.

11. A method for reading indicia comprising the steps of:
reading a first object with a programmable scanning apparatus providing a verb configuration indicating the type of programming actions to be taken by the apparatus;
initiating a program internal to the programmable scanning apparatus as a result of reading said first object and formatting said program to read the verb configuration as a result of reading said first object;
reading a second object with said programmable scanning apparatus, indicating a symbology type to which said verb configuration is to be applied; and
formatting said program to perform said verb configuration upon the symbology type of the second object with target objects to be read.

12. The method of claim 11 wherein said step of reading a second object comprises reading a plurality of objects having different symbology types and selectively formatting said program to perform the verb configuration upon the symbology types of the plurality of objects with target objects to be read.

13. The method of claim 11 further comprises the step of reading a third object scanned by the apparatus for terminating the program's ability to be selectively formatted.

14. The method of claim 12 further comprises the step of reading a third object scanned by the apparatus for terminating the program's ability to be selectively formatted.

15. The method of claim 11 wherein said scanning apparatus is a portable hand-held scanner.

16. The method of claim 11 wherein said scanning apparatus is a scan engine for use in either a stationary or portable scanner.

17. The method of claim 11 wherein said second object is one of said target objects to be read.

18. The method of claim 11 wherein said first object is a barcode and the second object is an RFID tag.

19. The method of claim 14 wherein said first, second, and third objects are barcodes.

20. A scanner for scanning indicia comprising:
a programmable scanning means capable of reading a first indicia in the form of a barcode scanned by the scanner, said first indicia initiating a program internal to the scanner providing a verb configuration indicating the type of programming actions to be taken by the scanner;
the programmable scanning means being capable of reading a second indicia in the form of a barcode, RFID tag, or RFID tag and barcode scanned by the scanner, said second indicia being decoded by a decoding means internal to said programmable scanning means to provide a symbology type, wherein said program is selectively formatted by the first indicia scanned to perform the verb configuration upon the symbology type of the second indicia in target indicia to be read.

21. The apparatus of claim 1 wherein said program is selectively formatted to perform the verb configuration upon target objects to be read such that symbology type is a type of RFID tag.

22. The apparatus of claim 1 wherein said verb configuration performs one of an enabling or disabling the symbology type.

23. The apparatus of claim 21 wherein said verb configuration performs one of an enabling or disabling of the type of RFID tag.
